(19) United States
(12) Patent Application Publication
(10) Pub. No.: US 2024/0086300 A1
(43) Pub. Date: Mar. 14, 2024

(54) ANALYSIS APPARATUS, ANALYSIS METHOD, AND PROGRAM

(71) Applicant: Nippon Telegraph and Telephone Corporation, Tokyo (JP)

(72) Inventors: Masaru Sakai, Musashino-shi, Tokyo (JP); Kensuke TAKAHASHI, Musashino-shi, Tokyo (JP)

(21) Appl. No.: 18/271,351

(22) PCT Filed: Jan. 8, 2021
(86) PCT No.: PCT/JP2021/000481

§ 371 Date: Jul. 7, 2023

(51) Int. Cl. G06F 11/34

(52) U.S. Cl. CPC G06F 11/3466

(57) ABSTRACT

Provided is a service graph analysis device 10 which detects anomalies of a monitored service 100 that implements specific features by a chained operation of multiple components. The service graph analysis device 10 includes an extraction unit 11 configured to extract a processing start event and a processing end event from monitoring data and generate a firing sequence arranging the events in chronological order, the monitoring data including information on a series of processing in the monitored service 100; and a detection unit 12 configured to determine whether the event arranged in the firing sequence can be fired in a service graph illustrating a dependency between components constituting the monitored service 100, and detect anomalies in a case where there is a non-fired event.

### TECHNICAL FIELD

The present invention relates to an analysis device, an analysis method and a program.

### BACKGROUND ART

In recent years, a microservice architecture has been widely provided in which applications for providing services such as web or ICT services are divided for each feature as components and the components communicate with each other to make a chained operation. For microservice management, not only metric or log monitoring at a resource level but also monitoring at an application level is required. For example, event logs occurred while running an application and the metrics in the application (including the number of HTTP requests, the number of transactions and the waiting time for each request) are aggregated and monitored in the application, whereby it is possible to support anomaly detection and root cause analysis in a complicated microservice.

As an example of an application-level monitoring scheme, visualization of component traces for one request to the application has been proposed. This is called tracing. Non Patent Literatures 1 and 2 respectively disclose black box-based tracing software that acquires operation history data without modifying the application itself. Non Patent Literatures 3 and 4 respectively disclose annotation-based tracing software that acquires operation history data by modifying the application. By visualizing of various microservice traces as a series of flows and displaying to a maintenance engineer or a developer, it is possible to help discover unusual traces and root causes of anomalies.

### CITATION LIST

### Non Patent Literature

Non Patent Literature 1: B. Sang, J. Zhan, G. Lu et al., “Precise, Scalable, and Online Request Tracing for Multitier Services of Black Boxes”, IEEE Transactions on Parallel and Distributed Systems, vol. 23, no. 6, pp. 1159-1167, 2012.
Non Patent Literature 2: X. Zhao, Y. Zhang, D. Lion et al., “lprof: A Non-intrusive Request Flow Profiler for Distributed Systems”, 11th USENIX Symposium on Operating Systems Design and Implementation (OSDI '14), pp. 629-644, 2014.
Non Patent Literature 3: B. H. Sigelman, L. A. Barroso, M. Burrows, P. Stephen-son, M. Plakal, D. Beaver, S. Jaspan, and C. Shanbhag. “Dapper, a large-scale distributed systems tracing infrastructure”, Technical report, Google, Inc., 2010.
Non Patent Literature 4: “Jaeger: open source, end-to-end distributed tracing”, [online], Internet <URL:https://www.jaegertracing.io/>

### SUMMARY OF INVENTION

### Technical Problem

Application-level monitoring data keeps accumulating every time an application runs, and thus it is not practicable for a person to check each piece of data in real time.

The inventors have proposed a method of estimating an inter-component dependency and creating a service graph representing dependencies between all components across the service by a Petri net in “Proposal of Service Graph Buildup based on Trace Data of Multiple Services” (IEICE Journal, Vol. 119, No. 438). Accordingly, it is possible to construct the service graph representing the inter-component dependency using the monitoring data.

Abnormal behaviors can be discovered by detecting monitoring data that does not follow the constructed service graph, and it is impossible to manually check a myriad pieces of monitoring data piece by piece to find anomalies.

The present invention is intended to deal with the problems stated above, and an object thereof is to extract abnormal monitoring data.

### Solution to Problem

According to one aspect of the present invention, provided is an analysis device for detecting anomalies in a service that implements specific features by means of a chained operation of multiple components, the analysis device including: an extraction unit configured to extract a processing start event and a processing end event from monitoring data and generate a firing sequence arranging the events in chronological order, the monitoring data including information on a series of processing in the service; and a detection unit configured to determine whether the event arranged in the firing sequence can be fired in a service graph illustrating a dependency between components constituting the service, and detect anomalies in a case where there is a non-fired event.

### Advantageous Effects of Invention

According to the present invention, it is possible to extract abnormal monitoring data.

### BRIEF DESCRIPTION OF DRAWINGS

FIG. 1 is a diagram illustrating one example of an overall configuration of a maintenance control system including a service graph analysis device of the present embodiment.

FIG. 2 is a functional block diagram illustrating one example of a configuration of the service graph analysis device.

FIG. 3 is a diagram illustrating one example of trace data.

FIG. 4 is a diagram in which components are represented by Petri nets.

FIG. 5 is a diagram representing an inter-component patent-progeny relationship by Petri nets.

FIG. 6 is a diagram representing an inter-component order relation by Petri nets.

FIG. 7 is a diagram representing an inter-component exclusive relationship by Petri nets.

FIG. 8 is a diagram illustrating one example of a service graph.

FIG. 9 is a sequence diagram illustrating one example of a processing flow of the maintenance control system.

FIG. 10 is a flowchart illustrating one example of a processing flow of the service graph analysis device.

FIG. 11 is a flowchart illustrating one example of a processing flow of the service graph analysis device.

FIG. 12 is a diagram illustrating suspicious events on a service graph.

FIG. 13 is a diagram illustrating one example of a hardware configuration of the service graph analysis device.

### DESCRIPTION OF EMBODIMENTS

Hereinbelow, the present embodiment will be described with reference to drawings.

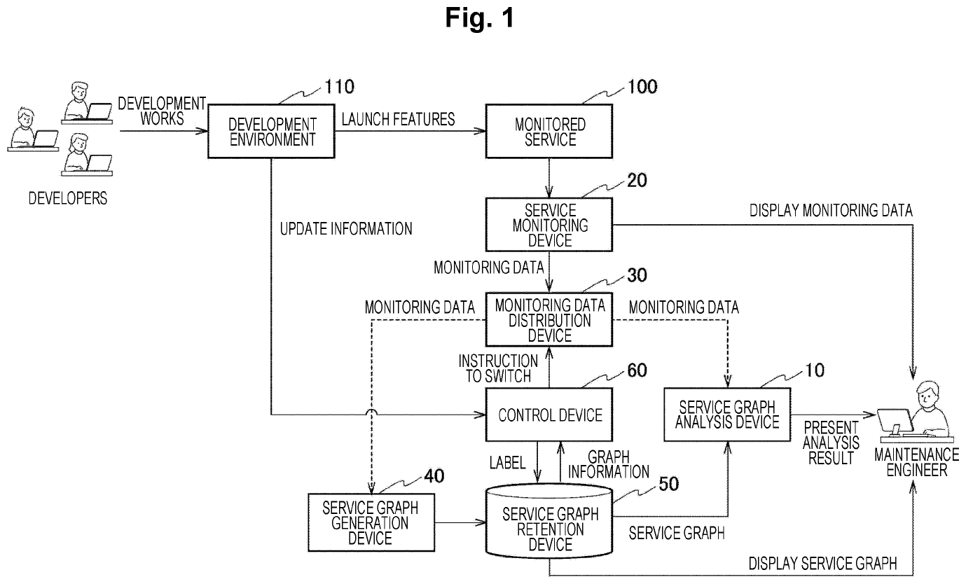

Referring to FIG. 1, an overall configuration of a maintenance control system including a service graph analysis device 10 of the present embodiment will be described. The maintenance control system shown in FIG. 1 includes a service graph analysis device 10, a service monitoring device 20, a monitoring data distribution device 30, a service graph generation device 40, a service graph retention device 50, and a control device 60.

A monitored service 100 includes a plurality of components and implements specific features by a chain operation of the multiple components. A component is a program that has an interface capable of exchanging requests and responses with other components and is implemented in various program languages.

The service monitoring device 20 is a device for monitoring the monitored service 100 at an application level, and for visualizing traces of the components for one request. The service monitoring device 20 can adopt technologies described in Non Patent Literatures 1 to 4. For example, the service monitoring device 20 records processing in each component of the monitored service 100 as a span element, and visualizes a flow of operations in the monitored service 100 for one request as trace data (hereinafter sometimes also referred to as “monitoring data”). A code for carrying a label is embedded in each component of the monitored service 100 to acquire the span element. The service monitoring device 20 displays the visualized trace data to a maintenance engineer. The maintenance engineer can check application-level behaviors of the monitored service 100 with the visualized trace data.

The monitoring data distribution device 30 receives the monitoring data from the service monitoring device 20, and distributes the monitoring data to the service graph generation device 40 or to the service graph analysis device 10 according to an operation phase of the maintenance control system. More particularly, the monitoring data distribution device 30 distributes the monitoring data to the service graph generation device 40 in a learning phase, and to the service graph analysis device 10 in a detection phase. A service graph is updated based on the monitoring data from the service graph generation device 40 in the learning phase. The monitoring data is checked in the service graph by the service graph analysis device 10 in the detection phase. A service graph is a graph structure representing dependencies between components constituting the monitored service 100. The service graph can be used to represent a state transition of flows of operations in the monitored service 100. The monitoring data distribution device 30 switches distribution destinations of the monitoring data based on an instruction from the control device 60.

The service graph generation device 40 receives the monitoring data in the learning phase, estimates inter-component dependencies from the monitoring data, updates the service graph based on the estimated dependencies, and stores the service graph in the service graph retention device 50.

The service graph retention device 50 retains the service graph. The service graph retained by the service graph retention device 50 is displayed to the maintenance engineer, or used by the service graph analysis device 10 to analyze the monitoring data. A normal label is given to the service graph retained by the service graph retention device 50 in the detection phase, and is removed from the service graph in the learning phase. The service graph to which the normal label is given corresponds to a normal model in which the graph update converges and is determined.

The developer develops and updates the monitored service 100 in development environment 110. When updating the monitored service 100, the development environment 110 sends an update timing notification to the control device 60.

The control device 60 switches between the learning phase and the detection phase on the basis of update information received from the development environment 110 and the convergence determination of the service graph. Specifically, when receiving a notification indicating that the monitored service 100 has been updated from the development environment 110 during the detection phase, the control device 60 shifts to the learning phase and issues an instruction to switch a distribution destination of the monitoring data to the service graph generation device 40. The control device 60 determines the update convergence of the service graph retained by the service graph retention device 50 during the learning phase, shifts to the detection phase when determining that the service graph update has converged, and issues an instruction to switch the distribution destination of the monitoring data to the service graph analysis device 10.

The service graph analysis device 10 receives the monitoring data in the detection phase, and determines whether a behavior is abnormal by checking executability of a state transition of the monitoring data in the service graph. When the abnormal behavior is detected, the service graph analysis device 10 presents the analysis result to the maintenance engineer.

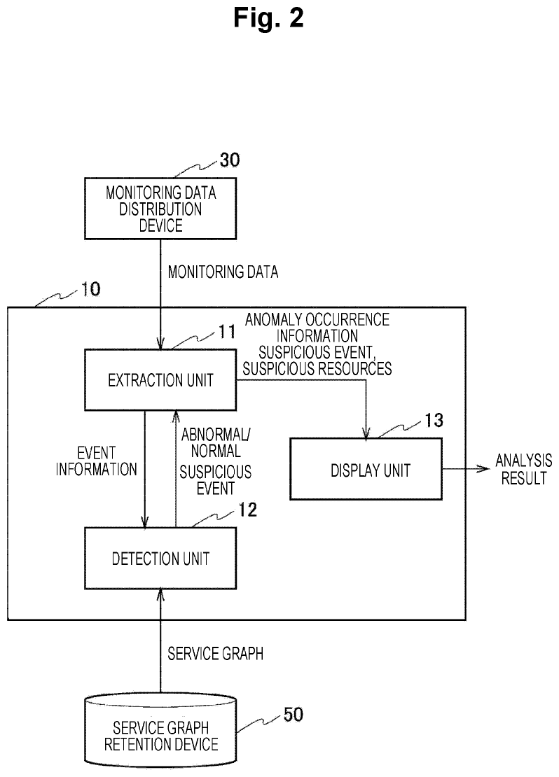

A configuration of the service graph analysis device 10 will be described with reference to FIG. 2. The service graph analysis device 10 illustrated in FIG. 2 includes an extraction unit 11, a detection unit 12, and a display unit 13.

The extraction unit 11 extracts all the processing start and processing end events from the monitoring data, and sorts the extracted events in chronological order to create a firing sequence to be checked.

In a case where a suspicious event in which the anomaly is detected is received from the detection unit 12, the extraction unit 11 lists resources used by the suspicious event from the monitoring data as suspicious resources.

The detection unit 12 checks whether each event in the firing sequence created from the monitoring data in the service graph retained by the service graph retention device 50 can be fired, determines that the abnormal behavior has occurred in a case where there is a non-fired event in the firing sequence, and extracts the suspicious event leading to a failure cause state.

When the detection unit 12 detects the abnormal behavior, the display unit 13 presents the analysis result obtained by visualizing the suspicious event and the suspicious resources to the maintenance engineer.

The service graph generated from the trace data (monitoring data) will be described below. The service graph analysis device 10 checks the firing sequence generated from the monitoring data using the service graph.

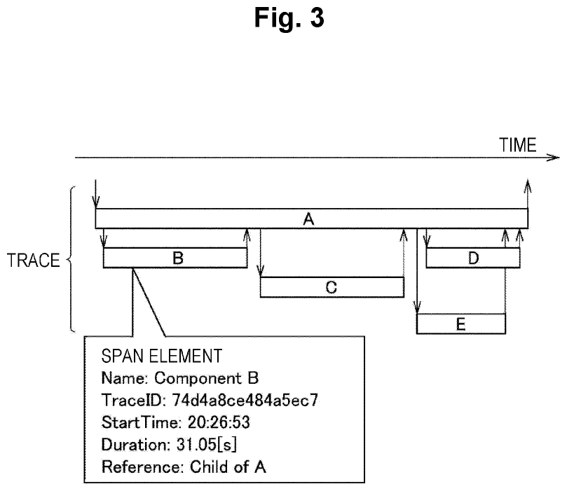

The trace data is a set of span elements constituting a series of processing from a request for the monitored service 100 to a response. For example, one piece of trace data from one request made by an end user to the monitored service 100 to a response is obtained. The span element is data in which time data of processing of each component and a parent-progeny relationship are recorded. FIG. 3 illustrates one example of the visualized trace data. In FIG. 3, a horizontal axis represents time, and a processing period of the component is represented by a rectangular width. Each of the five rectangles with letters A to E indicates the span element of each component. Arrows indicate exchanges of requests and responses between components. The span element includes, for example, information on a component name (Name), a trace ID (TraceID), a processing start time (StartTime), a processing period (Duration), and a relationship (Reference).

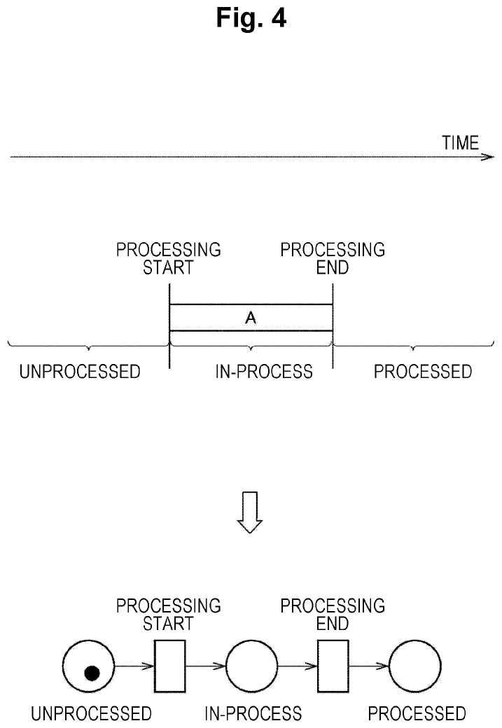

Referring to FIGS. 4 to 7, a method of representing a service graph based on inter-component dependencies will be described.

The service graph generation device 40 estimates an inter-component dependency from time information of each span element of the trace data, and represents a component-level service graph of the entire monitored service 100 by a Petri net on the basis of the estimated dependency. The Petri net is a two-part directed graph having two types of nodes, place and transition, connected by arcs. A variable called a token is given to the place. A state of the entire Petri net represented by the number of tokens held by each place is referred to as a marking. In particular, a marking in the initial state of the Petri net is referred to as an initial marking. The transition transfers tokens of all the places existing before a certain place to all the successive places by firing. The transition firing causes the Petri net to transition from the initial marking to the next marking.

In the present embodiment, a Petri net of one component is defined as illustrated in FIG. 4.

Specifically, three types of states taken by the component include “unprocessed”, “in-process”, and “processed”, which are associated with places. A state transition of the component is represented by moving a token by firing (processing start or processing end) of the inter-place transition. The token is a black circle arranged at the unprocessed place in FIG. 4. When the component shown in FIG. 4 starts processing, the token is moved to the in-process place.

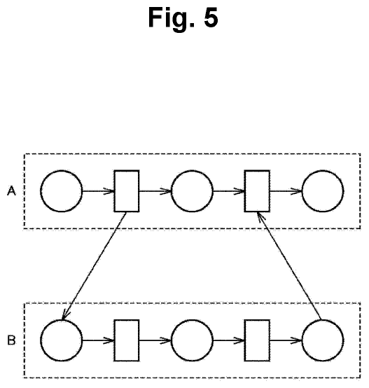

The inter-component dependency can be represented by adding an arc and a place to the Petri net of the components illustrated in FIG. 4. Specifically, as illustrated in FIGS. 5 to 7, a parent-progeny relationship, an order relation, and an exclusive relationship between components are expressed. The parent-progeny relationship is a relationship in which one component calls the other component. The order relation is a relationship in which one component is always executed after processing of the other component. The exclusive relationship is a relationship in which components never run in parallel.

A parent-progeny relationship between components A and B can be represented as illustrated in FIG. 5. An arc connects from a transition of processing start of the parent component A to an unprocessed place of the progeny component B, and another arc connects from a processed place of the progeny component B to a transition of processing end of the parent component A. It shows that the processing of the component B starts after the processing start of the component A, the component B enters a processed state after the processing end of the component B, and then the processing of the component A ends.

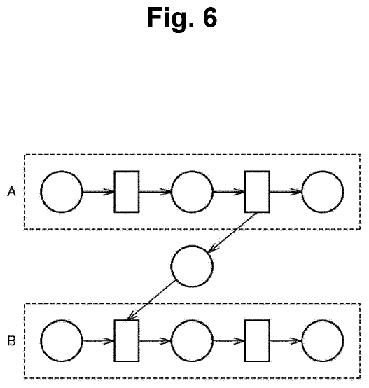

An order relation between the components A and B can be represented as illustrated in FIG. 6. New arc and new place are arranged at the transition of processing end of the component A, and another arc connects from the new place to a transition of processing start of the component B. It shows that the processing of the component B starts after the processing end of the component A.

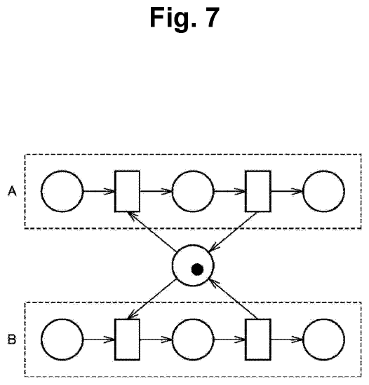

An exclusive relationship between the components A and B can be represented as illustrated in FIG. 7. A new place indicating a state in which both the component A and the component B are not being processed is arranged, and a token is arranged at the new place. Arcs respectively connect from transitions of processing end of the components A and B to the new place, and the other arcs respectively connect from the new place to transitions of processing starts of the components A and B. It shows that the processing of the component C or the component B starts after the processing end of the component B or the component C.

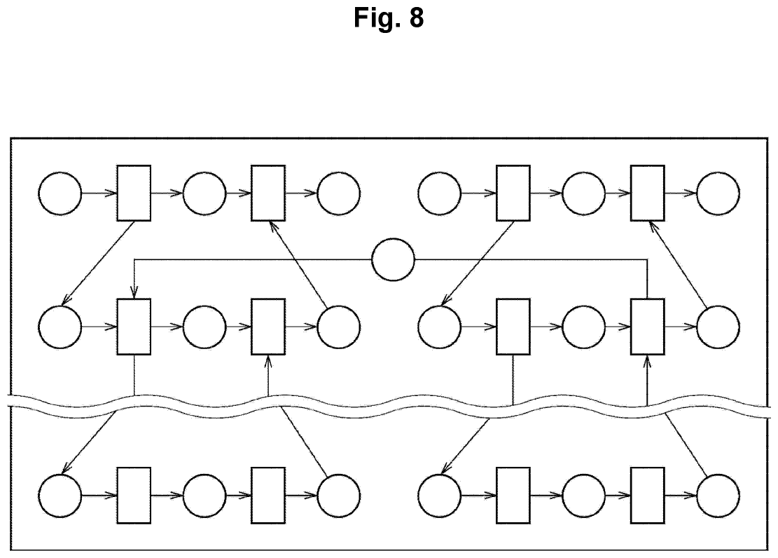

FIG. 8 illustrates one example of a service graph of the monitored service 100. All components constituting the monitored service 100 and inter-component dependencies are represented in the service graph of FIG. 8. When the monitoring data is distributed to the service graph generation device 40, the service graph generation device 40 compares the time data between span elements of sibling components with respect to each piece of the trace data included in the monitoring data, estimates the order relation or the exclusive relationship between the components, and updates the service graph. The service graph generation device 40 adds a graph representing a dependency by the method above for a newly discovered inter-component dependency, and removes a graph representing a dependency for a lost dependency.

The service graph analysis device 10 extracts processing start and processing end events from the trace data to create a firing sequence, sets an initial marking of the service graph, and checks whether events in the firing sequence can be sequentially fired. If there is a non-fired event, it is determined as an abnormal behavior.

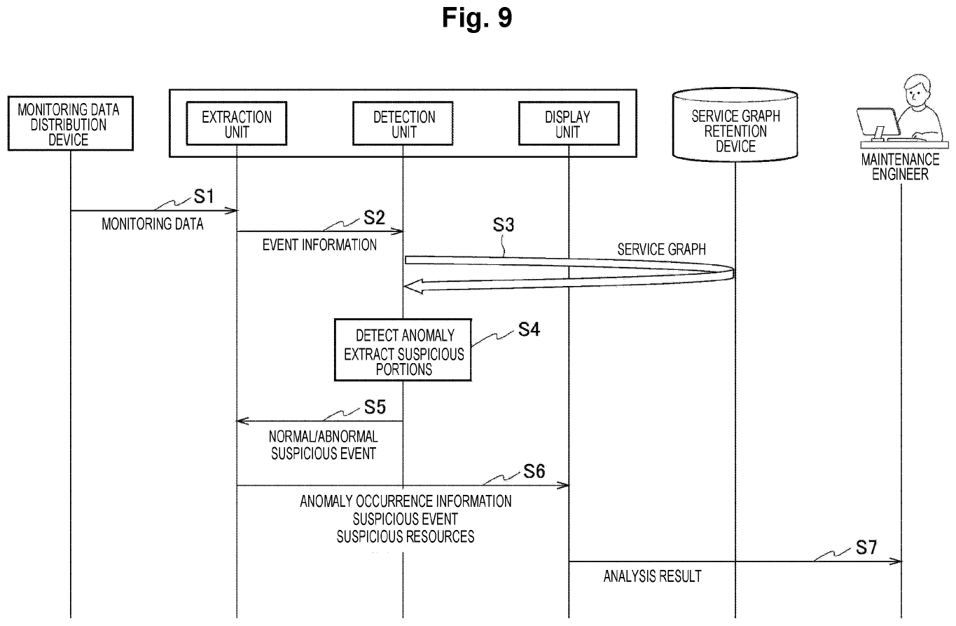

A flow of processing of the maintenance control system will be described with reference to a sequence diagram shown in FIG. 9.

When receiving the monitoring data from the monitoring data distribution device 30 in step S1, the extraction unit 11 extracts processing start and processing end events from the monitoring data, creates a firing sequence sorted in chronological order, and transmits the firing sequence to the detection unit 12 in step S2.

The detection unit 12 acquires a service graph from the service graph retention device 50 in step S3, and the detection unit detects an anomaly by sequentially shifting the service graph from an initial marking according to the firing sequence in step S4.

The detection unit 12 transmits the check result of the firing sequence to the extraction unit 11 in step S5. In a case where the anomaly is detected, the detection unit 12 notifies the extraction unit 11 of a suspicious event.

In a case where the detection unit 12 detects the anomaly, in step S6, the extraction unit 11 extracts suspicious resources corresponding to the suspicious event from the monitoring data, and transmits anomaly occurrence information including the suspicious event and the suspicious resources to the display unit 13.

The display unit 13 presents the analysis result including the suspicious event and the suspicious resources to a maintenance engineer in step S7.

In a case where the detection unit 12 detects no anomaly, the processing of steps S6 and S7 is not performed.

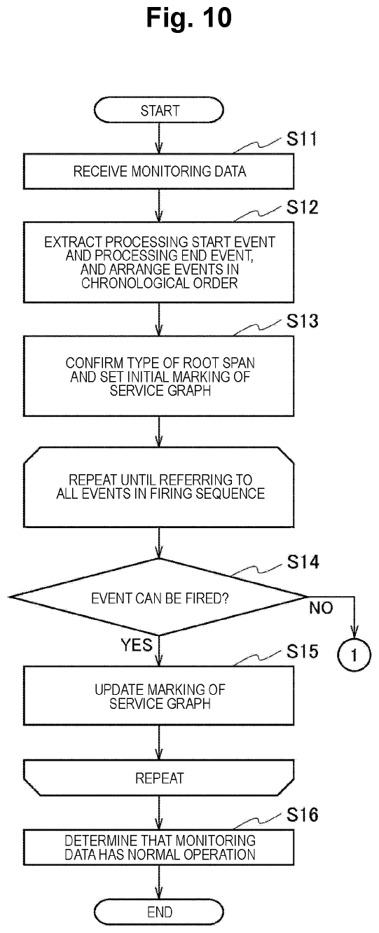

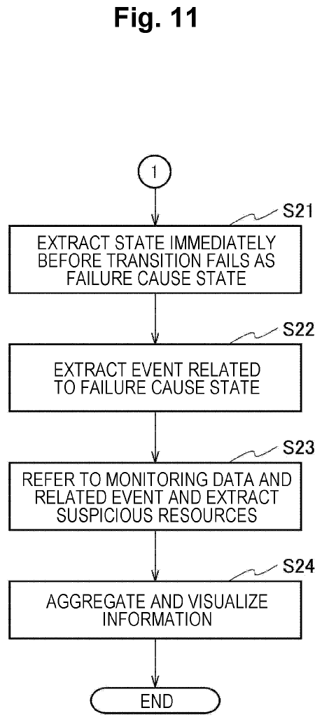

A processing flow of the service graph analysis device 10 will be described below with reference to flowcharts shown in FIGS. 10 and 11.

When the extraction unit 11 receives the monitoring data in step S11 of the flowchart shown in FIG. 10, all processing start and processing end events are extracted from the monitoring data to create a firing sequence sorted in chronological order for further check in step S12. When creating the firing sequence, the extraction unit 11 checks the naming rule and appropriately processes an event name included in the firing sequence such that the event name matches a name of the transition in the service graph. For example, “_ start” indicating the processing start or “_ end” indicating the processing end is added to a “processing name” of the event.

In step S13, the detection unit 12 checks the type of a root span and sets the initial marking of the service graph. The root span is a span element at which processing is initiated first. The initial marking is, for example, a state in which one token is placed at an unprocessed place in a subgraph corresponding to the root span.

All the events in the firing sequence are processed in chronological order, and the detection unit 12 searches, from the service graph, for a transition corresponding to a processed event and checks a firing availability of the transition in step S14. In a case where all the input places of the transition have tokens, the processed event can be fired.

In a case where the processed event can be fired, the detection unit 12 updates the marking of the service graph in step S15.

If all the events in the firing sequence can be fired, the detection unit 12 determines that normal operations are detected from the monitoring data, and notifies the extraction unit 11 that only the normal operations are discovered in the monitoring data in step S16.

In a case where the firing sequence includes a non-fired event, the detection unit 12 determines that the monitoring data contains an abnormal operation and advances the processing to the flowchart shown in FIG. 11.

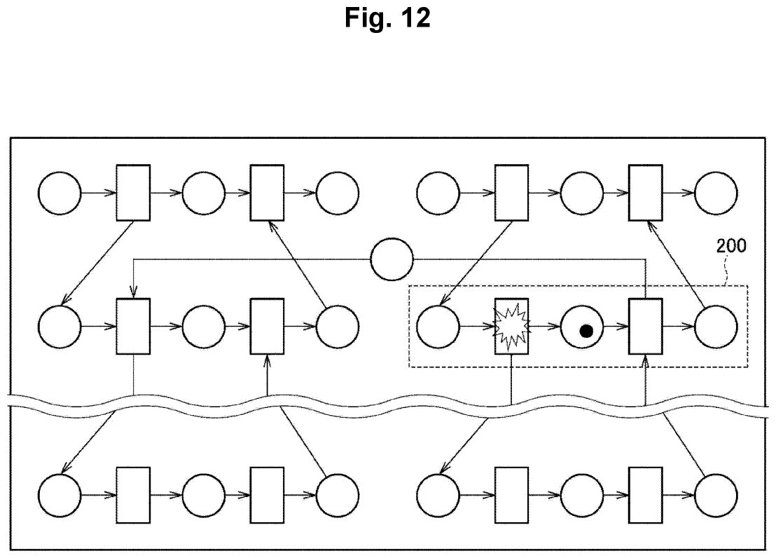

In step S21 of the flowchart shown in FIG. 11, the detection unit 12 extracts a marking that fails to transition without firing as a failure cause state, and extracts an event related to the failure cause state as a suspicious event in step S22. A span element including a place having a token in a marking of the failure cause state is a span element in which the processing has been performed until immediately before, and is included as a suspicious portion. For example, a subgraph (span element) indicated by a reference numeral 200 is a suspicious portion in the service graph of FIG. 12. The detection unit 12 acquires a union of transitions before the place having the token in the failure cause state, and lists all events corresponding to the transitions included in the union as suspicious events. In the service graph of FIG. 12, a transition before the place having the token is taken as a suspicious event. In a case where a plurality of places have tokens, a plurality of events may be listed as suspicious events. In a case where there are a plurality of transitions before the place, a plurality of events may be listed as suspicious events.

In step S23, the extraction unit 11 refers to the monitoring data corresponding to the suspicious event and extracts suspicious resources. The monitoring data may include resource information such as IP address of a virtual machine executing the processing. The extraction unit 11 lists a union of resources used by the suspicious event as suspicious resources. A cause event and a cause resource can be identified in a simple case. However, in a case where there is a plurality of waiting processes and there are many suspicious events that can be causes, cause resources may not be identified.

The display unit 13 visualizes and presents the suspicious event and the suspicious resources to a maintenance engineer in step S24. The display unit 13 may visualize and present the monitoring data determined to be abnormal to the maintenance engineer.

As described above, the service graph analysis device 10 according to the present embodiment includes the extraction unit 11 configured to extract the processing start event and the processing end event from the monitoring data and generate the firing sequence arranging the events in chronological order, the monitoring data including information on a series of processing in the monitored service 100; and the detection unit 12 configured to determine whether the event arranged in the firing sequence can be fired in the service graph illustrating the dependency between the components constituting the monitored service 100, and detect anomalies in a case where there is the non-fired event. In the service graph, states before, during, and after processing of the components are represented as places in a Petri net, processing start and processing end of the components are expressed as transitions in the Petri net, and inter-component dependencies are denoted by arranging new nodes and arcs between the Petri nets of the components. In the service graph having a non-fired event in a firing sequence, the detection unit 12 detects, as a component in which an anomaly has occurred, a component corresponding to a subgraph including a place in which a token is arranged. Accordingly, the abnormal monitoring data can be extracted using the service graph.

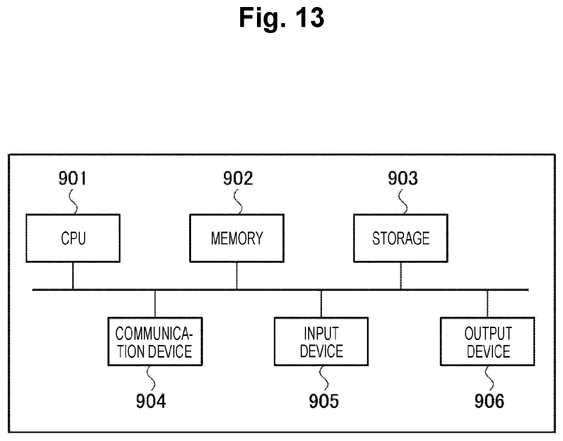

As the service graph analysis device 10 described above, a general-purpose computer system can be used, for example, including a central processing unit (CPU) 901, a memory 902, a storage 903, a communication device 904, an input device 905, and an output device 906 as illustrated in FIG. 13. In this computer system, the CPU 901 executes a predetermined program loaded on the memory 902, thereby implementing the service graph analysis device 10. This program can be recorded on a computer-readable recording medium such as a magnetic disk, an optical disk, or a semiconductor memory, or can be distributed via a network.

### REFERENCE SIGNS LIST

10 Service graph analysis device
11 Extraction unit
12 Detection unit
13 Display unit
20 Service monitoring device
30 Monitoring data distribution device
40 Service graph generation device
50 Service graph retention device
60 Control device
100 Monitored service
110 Development environment

1. An analysis device for detecting anomalies in a service that implements specific features by means of a chained operation of multiple components, the analysis device comprising:
an extraction unit, including one or more processors, configured to extract a processing start event and a processing end event from monitoring data and generate a firing sequence arranging the events in chronological order, the monitoring data including information on a series of processing in the service; and
a detection unit, including one or more processors, configured to determine whether the event arranged in the firing sequence can be fired in a service graph illustrating a dependency between components constituting the service, and detect anomalies in a case where there is a non-fired event.

2. The analysis device according to claim 1, wherein
the detection unit is configured to extract a suspicious event in which an anomaly has occurred from a state of the service graph with a non-fired event, and
the extraction unit is configured to extract a resource in which an anomaly has occurred based on the suspicious event in which the anomaly has occurred.

3. The analysis device according to claim 1, wherein
the service graph represents a state before, during and after processing of the component as places in a Petri net, represents processing start and processing end of the component as transitions in the Petri net, and represents a dependency between the components by arranging a new node and arc between the Petri nets of the components, and
the detection unit is configured to detect a transition before a place with a token placed, in the service graph with a non-fire event in the firing sequence, as a suspicious event in which an anomaly has occurred.

4. An analysis method by an analysis device for detecting anomalies in a service that implements specific features by means of a chained operation of multiple components, the analysis method comprising:
extracting a processing start event and a processing end event from monitoring data and generating a firing sequence arranging the events in chronological order, the monitoring data including information on a series of processing in the service; and
determining whether the event arranged in the firing sequence can be fired in a service graph illustrating a dependency between components constituting the service, and detecting anomalies in a case where there is a non-fired event.

5. A non-transitory computer-readable storage medium storing a program configured to cause a computer to perform operations of an analysis method for detecting anomalies in a service that implements specific features by means of a chained operation of multiple components, the operations comprising:
extracting a processing start event and a processing end event from monitoring data and generating a firing sequence arranging the events in chronological order, the monitoring data including information on a series of processing in the service; and
determining whether the event arranged in the firing sequence can be fired in a service graph illustrating a dependency between components constituting the service, and detecting anomalies in a case where there is a non-fired event.

6. The non-transitory computer-readable storage medium according to claim 5, wherein the operations further comprise:
extracting a suspicious event in which an anomaly has occurred from a state of the service graph with a non-fired event; and
extracting a resource in which an anomaly has occurred based on the suspicious event in which the anomaly has occurred.

7. The non-transitory computer-readable storage medium according to claim 5, wherein
the service graph represents a state before, during and after processing of the component as places in a Petri net, represents processing start and processing end of the component as transitions in the Petri net, and represents a dependency between the components by arranging a new node and arc between the Petri nets of the components, and
the operations further comprise detecting a transition before a place with a token placed, in the service graph with a non-fire event in the firing sequence, as a suspicious event in which an anomaly has occurred.

8. The analysis method according to claim 4, further comprising:
extracting a suspicious event in which an anomaly has occurred from a state of the service graph with a non-fired event; and
extracting a resource in which an anomaly has occurred based on the suspicious event in which the anomaly has occurred.

9. The analysis method according to claim 4, wherein
the service graph represents a state before, during and after processing of the component as places in a Petri net, represents processing start and processing end of the component as transitions in the Petri net, and represents a dependency between the components by arranging a new node and arc between the Petri nets of the components, and
the analysis method further comprises detecting a transition before a place with a token placed, in the service graph with a non-fire event in the firing sequence, as a suspicious event in which an anomaly has occurred.
